(19) United States
(12) Patent Application Publication
(10) Pub. No.: US 2002/0196440 A1
(43) Pub. Date: Dec. 26, 2002

(54) Structure for aligning chips in stacked arrangement

(76) Inventors: Dan A. Steinberg, Blacksburg, VA (US); Arden Jeantilis, Blacksburg, VA (US)

Correspondence Address: Adrian T. Calderone, DILWORTH & BARRESE, LLP, 333 Earle Ovington Blvd., Uniondale, NY, 11553, US

(21) Appl. No.: 10/015,271

(22) Filed: Dec. 13, 2001

Related U.S. Application Data
(60) Provisional application No. 60/255,866, filed on Dec. 14, 2000.

(51) Int. Cl. G01B 11/00

(52) U.S. Cl. 356/399

(57) ABSTRACT

A stacked assembly includes first and second substrates and at least one alignment member. The alignment member has a relatively wide diameter body portion and a relatively narrow diameter alignment projection extending from the body portion. The body portion is mounted in a groove in the upper surface of the second substrate and the alignment projection being mounted in the groove in the upper surface of the first substrate.

### CROSS-REFERENCE TO RELATED APPLICATIONS

This application claims priority to U.S. Provisional Application Serial No. 60/255,866, filed Dec. 14, 2000 the contents of which are herein incorporated by reference.

### BACKGROUND

1. Technical Field

The present disclosure relates to a stacked chip structure. More particularly, this disclosure is directed to a structure for stacking chips in an accurate alignment without performing a backside alignment procedure on the bottom surface of the top chip.

2. Background of Related Art

In general, assemblies utilizing silicon include those which employ a frontside/frontside alignment. For example, as shown in FIG. 1, an optical assembly can be formed by employing two silicon substrates 10 and 30. Top substrate 10 has an optical element 12 and fiducials 14 and 16 formed in the bottom surface 11 of substrate 12 for receiving alignment spheres 18 and 20 with the bottom surface being patterned. Bottom substrate 30 has an optical element 32 and fiducials 34 and 36 formed in the top surface 31 of substrate 30 for receiving alignment spheres 18 and 20 with the top surface being patterned. The optical elements 12 and 32 associated with substrates 10 and 30 can be aligned by way of the alignment spheres 18 and 20 received in the respective fiducials of substrates 10 and 30. However, it is sometimes necessary to align an optical device on the upper surface of the top substrate with an optical device on the upper surface of the bottom substrate as, for example, when signals are transmitted through the substrate. Such an alignment can pose difficulties.

For example, as shown in FIG. 2, when a top substrate 40 has an optical element 49 formed in the upper surface 41 thereof, and the upper surface 41 is patterned instead of the bottom surface 42, then a backside alignment procedure must be performed on the bottom surface 42 of substrate 40 to form fiducials 44 and 45 for receiving alignment spheres 18 and 20 to align top substrate 40 with bottom substrate 30. Problems associated with this type of alignment procedure is that inaccurate alignment will result. Typically, this type of alignment procedure will be accurate to within only 5 microns. However, for micromechanical or microoptical devices, alignment of the substrates should be within about 1 micron or lower.

It would be desirable to provide a more accurate alignment of two substrates for forming an optical connector system without performing a backside alignment procedure on the bottom surface of the top substrate.

### SUMMARY

A stacked assembly is provided herein, the stacked assembly comprising first and second substrates and at least one alignment member. The first substrate has an upper surface, a lower surface, and a groove in the upper surface. The second substrate has an upper surface, a lower surface and a groove in the upper surface, the lower surface of the first substrate and upper surface of the second substrate being in facing relation. The alignment member has a relatively wide diameter body portion and a relatively narrow diameter alignment projection extending from the body portion. The body portion is mounted in the groove in the upper surface of the second substrate and the alignment projection being mounted in the groove in the upper surface of the first substrate.

The stacked assembly provided herein advantageously can be formed by aligning the first substrate with the second substrate without performing a backside alignment procedure.

### BRIEF DESCRIPTION OF THE DRAWINGS

Various embodiments of the optical connector system of the present disclosure are described below with reference to the drawings wherein:

FIG. 1 is a schematic cross-sectional representation of a prior art alignment for a frontside-frontside alignment optical connector system;

FIG. 2 is a schematic cross-sectional representation of a prior art alignment for a frontside-backside alignment optical connector system;

FIG. 3 is an exploded perspective view of a mounting region of a stacked assembly in accordance with the invention;

FIG. 4 is a perspective view of a jig for making alignment members;

FIG. 5 is a schematic side view of the embodiment of FIG. 3;

FIG. 6 is an end view of an embodiment of an alignment member;

FIG. 7 is a schematic perspective view illustrating a mounting region of an embodiment of the invention incorporating the alignment member of FIG. 6;

FIG. 8 is a schematic side view illustrating an embodiment of the invention employing an alignment member with flat alignment surfaces;

FIG. 9 is a schematic perspective view of the mounting region of an embodiment of the invention wherein the alignment member includes an alignment ball;

FIG. 10 is a perspective view of the mounting region of an embodiment wherein the alignment rod of the alignment member is concentric with the body portion;

FIG. 11 is a perspective view showing a stacked assembly with multiple mounting points; and

FIG. 12 is a partly sectional perspective view of a mounting region of an embodiment using a block shaped alignment member.

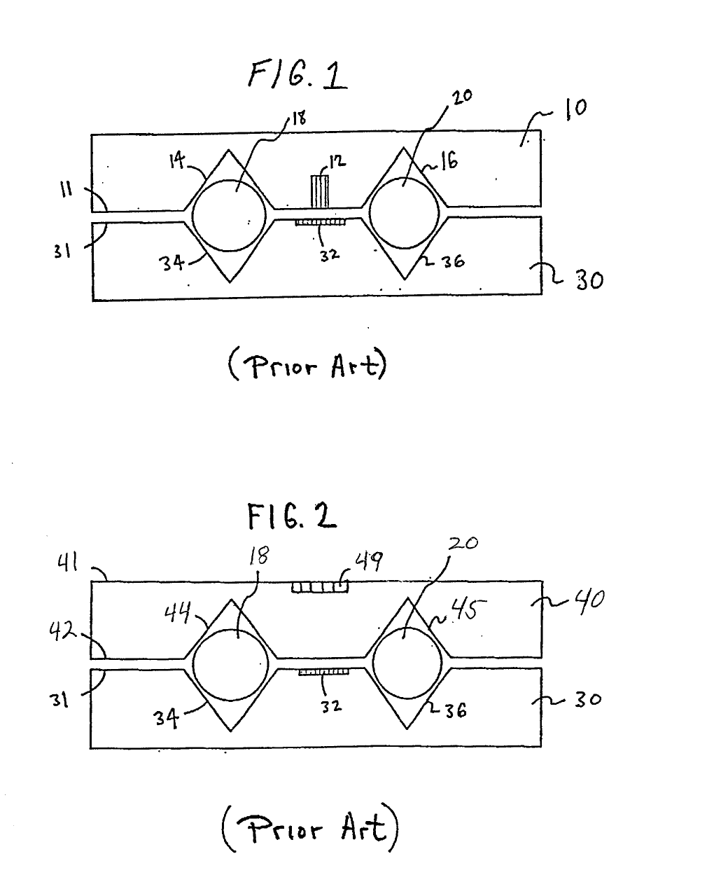

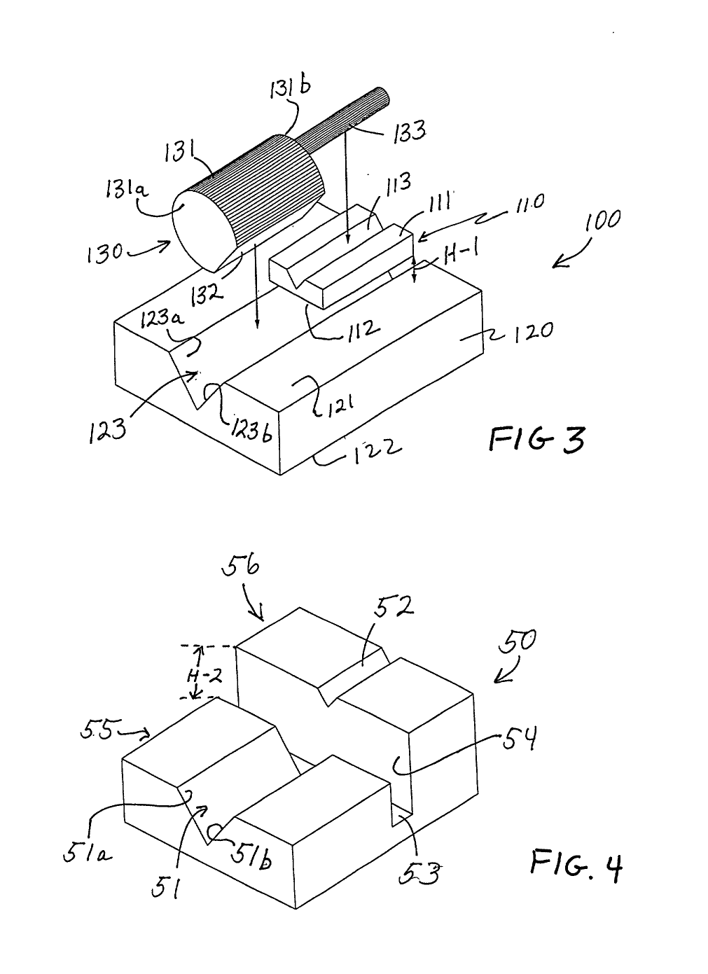

### DESCRIPTION OF THE PREFERRED EMBODIMENTS

The terms “top” and “bottom” are used herein relative to each other and as the embodiments are depicted in the drawings, and do not refer to any fixed external frame of reference.

The present stacked assembly is useful for aligning a wide range of different signal communication elements. For example, the connector system described herein can be used to align fiber arrays or a fiber array and a micro lens array. The present invention can also be used to align, for example, micromachined substrates for micromechanical or microoptical devices.

The stacked assembly includes at least one, and preferably at least three, alignment points for maintaining proper alignment of the substrates. At each alignment point an alignment member contacts a top substrate and a bottom substrate at respective mounting regions. FIGS. 3 and 5 to 10 are partial views showing the details of only a mounting region of the stacked assembly embodiments. Thus, for the purpose of clarity, only those regions of the substrates at which the alignment members are mounted are depicted. FIG. 11 illustrates the entire substrates.

Referring now to FIGS. 3 and 5, a stacked assembly 100 of the present invention includes at least one mounting region of a first top substrate 110, a mounting region of a second bottom substrate 120, and one or more alignment members 130.

The top substrate 110 includes an upper surface 111, a lower surface 120 and at least one groove 113. The bottom substrate 120 includes an upper surface 121, a lower surface 122 and at least one groove 123 having flat sides 123a and 123b. The top substrate is positioned above the bottom substrate such that the bottom surface 112 of the top substrate is separated from the upper surface 121 of the bottom substrate by a distance H-1, wherein H-1 can typically range from about 1 micron to about 5,000 microns, although distances outside of this range are also contemplated as being within the scope of the invention. As illustrated in an embodiment shown in FIG. 11, the upper surface of the top and bottom substrates can optionally each include a signal communication element mounted thereon for emitting, receiving, transmitting, carrying or modifying a signal. Optical signal communication elements include, for example, lenses, filters, optical fibers, laser diodes, photodetectors, and the like.

Both upper substrate 110 and lower substrate 120 can be fabricated from a variety of materials such as silicon (Si), gallium arsenide (GaAs), ceramics, metals, and polymeric materials such as high performance engineering plastic, and the like. Single crystal silicon is preferred.

The grooves 113 and 123 can be of any shape suitable for the purposes described herein. However, grooves having a V-shaped cross section, known as “V-grooves”, are preferred, as well as grooves having a U-shaped cross section, i.e., “U-grooves”. Grooves 113 and 123 are shown herein as V-grooves.

Single crystal silicon can be processed by known etching techniques to form the grooves. For example, anisotropic etching of silicon can be performed with etchants known to those with skill in the art such as potassium hydroxide (KOH) or ethylene diamine pyrocatechol (EDP). The depth and width of the grooves can be controlled with great precision.

The alignment member 130 includes a body portion 131 having proximal end surface 131a, distal end surface 131b, and a flat alignment surface 132. An alignment projection, i.e., alignment rod 133, extends distally from the distal end surface 131b of the body portion 131. Preferably, the alignment projection has a relatively smaller diameter than that of the body portion. The alignment member 130 can be of monolithic single piece construction, or can be fabricated by attaching a separately fabricated alignment rod 133 to the end 131b of the body portion, as discussed below.

Typically, the alignment member 130 will have a length of from about 1 mm to about 1 cm; the body portion will have a diameter of from about 0.5 mm to about 4 mm; and the alignment rod will have a diameter ranging from about 0.25 mm to about 2 mm. These dimensions are given for purposes of illustration only. Alignment members can have dimensions outside of these given ranges and are still considered to be within the scope of the invention.

The alignment member 130 can be fabricated from any material suitable for the purposes described herein such as, for example, ceramics (e.g., silicon nitride, alumina, silicon carbide, etc.), and metals (e.g., steel, titanium, aluminum, etc.).

The alignment member is positioned such that the body portion is mounted into groove 123 with flat alignment surface 132 flush against one of flat sides 123a or 123b of the groove 123. As shown in FIGS. 3 and 5, alignment surface 132 is engaged with flat side 123b of the V-groove 123.

As can be appreciated, mass production of stacked arrays 100 requires consistency and precision in the configuration of the alignment members 130. The top substrate and bottom substrate generally require an alignment to within ±1 micron. However, the alignment rod 133 and body portion 131 can have variations ranging from 10 to 30 microns.

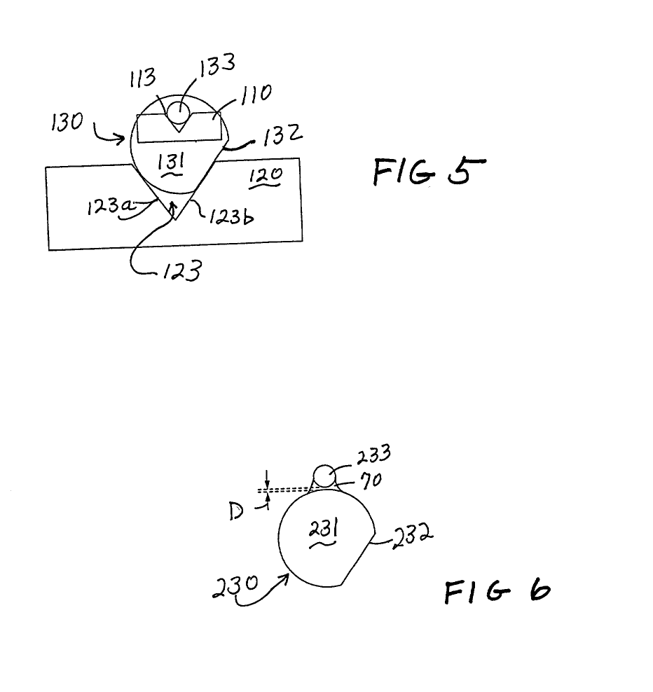

In a preferred method, the alignment member is made by bonding the alignment rod to the body portion using a precision jig. This enables a precision alignment member 130 to be fabricated from inaccurate alignment rod and body components. Referring now to FIG. 4, jig 50 is a single piece member which includes a V-groove 51 for receiving body portion 131 and groove 52 for receiving alignment rod 133. V-groove 51 is formed from flat sides 51a and 51b. A lateral cut-away portion 53 is at least partially defined by a proximal facing wall 54 and divides the jig into a proximal portion 55 and a distal portion 56. The top surface of distal portion 56 is higher than the top surface of proximal portion 55 by a predetermined distance H-2, wherein H-2 can be any appropriate distance. Typically, H-2 can range from about 0.5 mm to about 5 mm. The grooves 51 and 52, and the proximal and distal portions 55 and 56, are precisely configured, dimensioned and positioned to accurately represent the desired configuration and positioning of the top and bottom substrates 110 and 120. That is, jig 50 acts as a template of the top and bottom substrates so that highly accurate and precise alignment members can be fabricated from variable components. To fabricate the alignment member 130, body portion 131 is mounted in V-groove 51 such that alignment face 132 is flush against a side 51b of the V-groove 51, and the distal end surface 131b is flush against proximal wall 54. Alignment rod 133 is placed in groove 52 and the proximal end of the alignment rod 133 is fixedly attached to distal end surface 131b of the body portion by any suitable attachment means such as the use of bonding agent (e.g., epoxy adhesive), metal solder, solder glass, and the like.

The assembled alignment member is then used to align the top substrate 110 and the bottom substrate 120. It should be noted that body portion 131 is not rotatable when mounted in groove 123 because of the abutment of alignment surface 132 with flat side 123b of the groove. Therefore, the alignment rod 133 does not need to be concentric with respect to the body portion 131.

After being mounted in place the alignment member 130 can be securely fixed in position by a bonding process. For example, a bonding agent such as epoxy adhesive, solder metal or solder glass can be used to secure the body portion 131 in groove 123 and the alignment rod in groove 113. Alternative bonding processes include eutectic bonding, thermo-compression bonding, ultrasonic bonding, thermo-sonic bonding, or any other suitable technique.

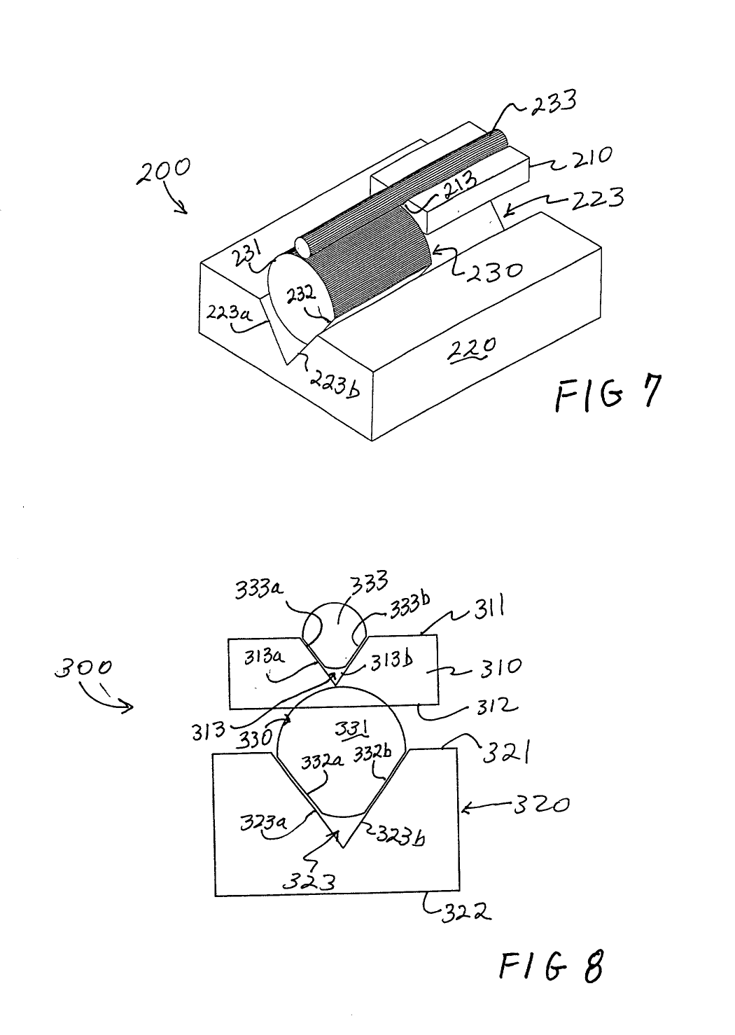

Referring now to FIGS. 6 and 7, the alignment rod and body do not have to be attached end to end. As can be seen from FIG. 6, alignment member 230 can be fabricated using jig 50 by fixedly securing an alignment rod 233 to body portion 231 in a side to side configuration. The body portion is seated in groove 51 of the jig with flat alignment surface 232 abutting a flat side surface 51b of V-groove 51. The alignment rod 233 is seated in groove 52 of the jig. However, the jig is fabricated such that height H-2 allows the proximal portion of the alignment rod 233 to lay across the top of the body portion 231. In a preferred embodiment there is a gap D between the bottom of the alignment rod 233 and the top of the body portion 231. Distance D can optionally range from about 10 microns to about 100 microns. The alignment rod and body portion are thereafter fixedly bonded to each other by means of a gap-filling bonding agent such as epoxy adhesive, solder metal, solder glass, and the like.

Referring to FIG. 7. the alignment member 230 is then used to fabricate a stacked assembly 200. Alignment rod is positioned within groove 213 in the mounting region of the upper surface of top substrate 210. The mounting region of bottom substrate 220 includes a V-groove 223 having flat sides 223a and 223b. Body portion 231 is mounted within V-groove 223 such that flat alignment surface 232 engages one of the flat sides (223b) of the V-groove so as to prevent rotation of the alignment member 230. The alignment member 230 can be fixedly secured to the substrates by means of any suitable bonding method, as set forth above.

Referring now to FIG. 8, stacked assembly 300 includes a mounting region of an upper substrate 310 having an upper surface 311, a lower surface 312, and a groove 313 in the upper surface 311. Groove 313 is defined by flat side surfaces 313a and 313b. The mounting region of bottom substrate 320 has upper surface 321, a lower surface 322, and a groove 323 in the upper surface 321. Groove 323 is defined by flat side surfaces 323a and 323b. The alignment member 330 is similar to alignment member 230 in that alignment rod 333 is bonded to the side of the body portion 331. However alignment rod 333 includes at least one, and preferably two flat alignment surfaces 333a and 333b. Body portion 331 includes at least one, and preferably two flat alignment surfaces 332a and 332b. When the stacked assembly 300 is assembled, flat alignment surfaces 333a and 333b of the alignment rod engage flat side surfaces 313a and 313b, respectively, of groove 313 in top substrate 310. And flat alignment surfaces 332a and 332b of the body portion 331 engage flat side surfaces 323a and 323b of groove 323 in bottom substrate 320.

The alignment member 330 can be fixedly secured to the substrates by means of any suitable bonding method such as set forth above.

Referring now to FIG. 9, stacked assembly 400 includes a mounting region of top substrate 410 having an upper surface with a groove 413. The mounting region of bottom substrate 420 has an upper surface with a groove 423. Alignment member 430 includes a body portion 431 having a flat alignment surface 432, and an alignment projection, i.e., alignment ball 433, fixedly attached to the distal end surface of the body portion. Body portion is positioned in groove 423 such that flat alignment surface 432 engages a flat side edge of groove 423. Alignment ball 433 is positioned within groove 413.

The alignment member 430 can be fixedly secured to the substrates by means of any suitable bonding method such as set forth above.

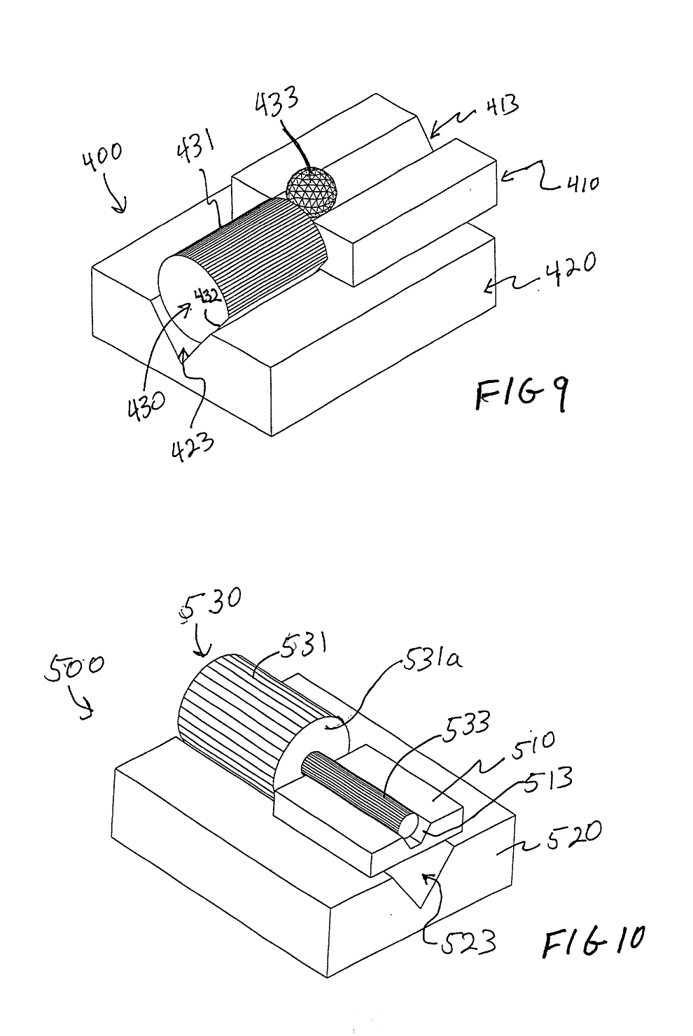

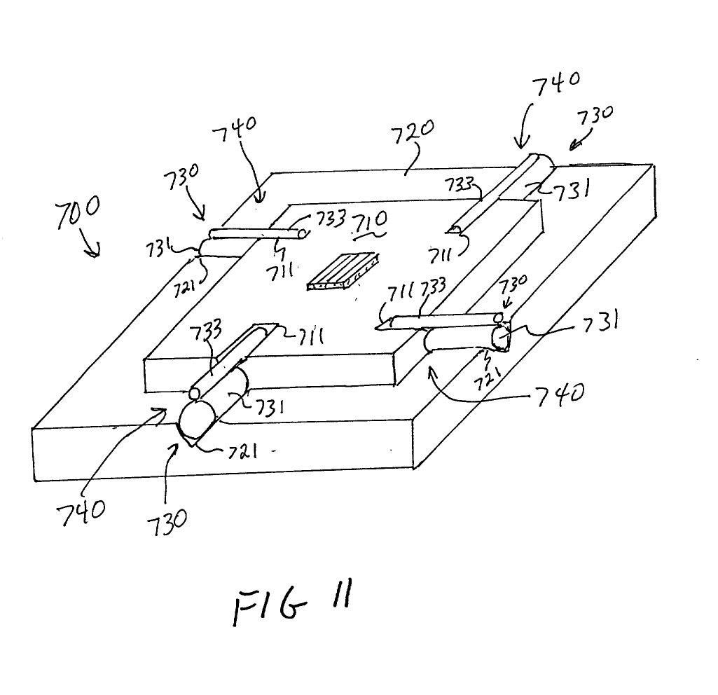

Referring now to FIG. 10, stacked assembly 500 includes a top substrate mounting region 510 having an upper surface with groove 513. Bottom substrate mounting region 520 has an upper surface with groove 523. Alignment member 530 includes a cylindrical body portion 531 and a cylindrical alignment rod 533 coaxially aligned with the body portion 531 and extending from an end surface 531a of the cylindrical body portion. Cylindrical body portion 531 is positioned in groove 523, and cylindrical alignment rod 533 is positioned in groove 513. Both cylindrical body portion 531 and cylindrical alignment rod 533 do not have any flat alignment surfaces. Therefore, the alignment member 530 is capable of rotating in the stacked assembly until fixed in position by, for example, a bonding process. Because the alignment member 530 is symmetrical around a longitudinal axis it can simply be dropped into place into the grooves 523 and 513 without the necessity of rotationally orienting it so that a flat alignment surface is aligned with a flat surface of the groove. It is, therefore, at least partially self aligning. Moreover, the grooves 513 and 523 can optionally have a semicircular shape, rather than a V-shape, because a flat sided groove is not necessary.

To achieve these advantages the alignment member 530 must be precisely machined such that the cylindrical body 531 and cylindrical alignment rod are concentric and that the diameters are uniform to within ±1 micron.

Alignment member 530 can be fabricated by joining two separate pieces, or can be machine from a single monolithic piece. Jig 50 can be used for making the alignment member 530. Also, alignment member 530 can be machined by a lathe, or by other suitable micromachining technologies.

Referring now to FIG. 11, a stacked assembly 700 is shown which includes top substrate 710, bottom substrate 720, and four mounting regions 740. At each mounting region 740, the body portion 731 of an alignment member 730 is mounted in V-groove 721 in the bottom substrate 720 such that the flat alignment surface 732 of the body portion is flush against a flat wall of the V-groove 721. Alignment rod 733 is fixedly secured to body portion 731 as described above with respect to FIGS. 6 and 7. Alignment rod 733 extends into groove 711 in the top substrate 710. A signal communication element 750 is mounted to the upper surface of the top substrate 710. A second signal communication element is at the upper surface of the bottom substrate.

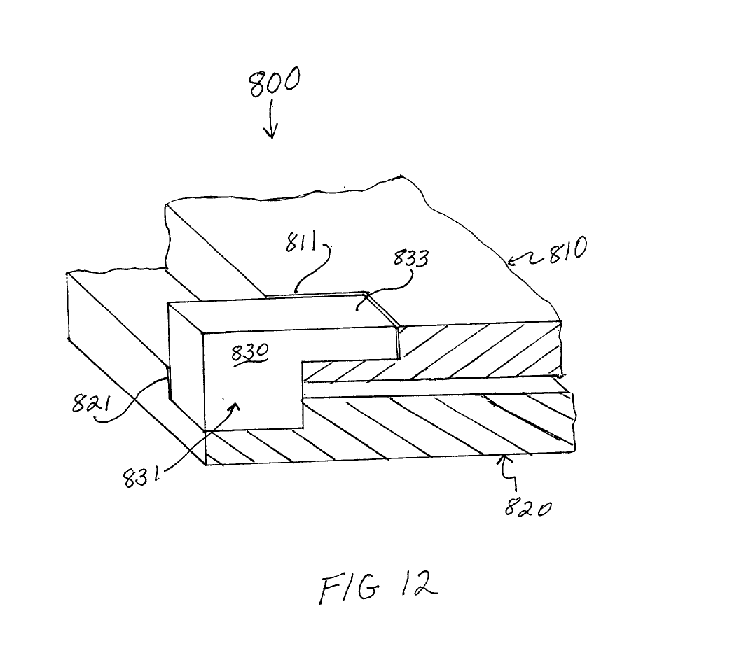

Referring to FIG. 12, a mounting region of a stacked assembly 800 is shown wherein top substrate 810 includes a rectangular shaped groove 811 in the upper surface thereof, and bottom substrate includes a rectangular shaped groove 821 in the upper surface thereof. A rectangular, block shaped alignment member 830 is mounted such that the body portion 831 of the alignment member is positioned in the groove 821 in the bottom substrate and the alignment projection 833 is positioned in groove 811 in the upper substrate. Alignment member can be fabricated as a single piece monolithic member, or can alternatively be formed by fixedly joining the alignment projection 833 to the body portion 831 by any of the processes described above.

Although the invention has been described in its preferred formed with a certain degree of particularity, many changes and variations are possible therein and will be apparent to those skilled in the art after reading the foregoing description. For example, while the connector system has been described herein with respect to optical connectors, the present system can be used in other applications such as, for example, for semiconductor connectors. It is therefore to be understood that the present invention may be presented otherwise than as specifically described herein without departing from the spirit and scope thereof.

What is claimed is:

1. A stacked assembly comprising:
a) a first substrate having an upper surface, a lower surface, and a groove in the upper surface;
b) a second substrate having an upper surface, a lower surface and a groove in the upper surface, said lower surface of the first substrate and upper surface of the second substrate being in facing relation;
c) an alignment member having a body portion and an alignment projection extending from the body portion, the body portion being mounted in the groove in the upper surface of the second substrate and the alignment projection being mounted in the groove in the upper surface of the first substrate.

2. The stacked assembly of claim 1 further comprising:
a first signal communication element associated with the first substrate for emitting, receiving, carrying or modifying a signal,
a second signal communication element associated with the second substrate for emitting, receiving, carrying or modifying a signal.

3. The stacked assembly of claim 2 wherein the first and second signal communication elements are optical elements.

4. The stacked assembly of claim 3 wherein the optical elements are selected from the group consisting of a lens, filter, optical fiber, laser diode and photodetector.

5. The stacked assembly of claim 1 wherein the alignment projection is a rod shaped.

6. The stacked assembly of claim 1 wherein the alignment projection is ball shaped.

7. The stacked assembly of claim 1 wherein the alignment member is block shaped.

8. The stacked assembly of claim 1 wherein the alignment projection has a relatively smaller diameter than the body portion.

9. The stacked assembly of claim 1 wherein the alignment member is fabricated by joining the alignment projection to the body portion wherein the alignment projection is attached to an end surface of the body portion.

10. The stacked assembly of claim 1 wherein the alignment member is formed by joining the alignment projection to the body portion wherein the alignment projection is attached to a side surface of the body portion.

11. The stacked assembly of claim 1 wherein the alignment member is of single-piece, monolithic construction.

12. The stacked assembly of claim 1 wherein the alignment projection extends from an end surface of the body portion, both the alignment projection and the body portion having a cylindrical shape, wherein the alignment projection has a relatively smaller diameter than the body portion, and wherein the alignment projection and the body portion are coaxially aligned.

13. The stacked assembly of claim 1 wherein the body portion has at least one flat alignment surface.

14. The stacked assembly of claim 1 wherein both the body portion and the alignment projection each have at least one flat alignment surface.

15. An optical assembly comprising:
a) a first substrate having an upper surface, a lower surface, a first optical element associated with the upper surface of the first substrate, and a groove in the upper surface of the first substrate;
b) a second substrate having an upper surface, a lower surface, a second optical element associated with the upper surface of the second substrate, and a groove in the upper surface of the second substrate, said lower surface of the first substrate and upper surface of the second substrate being in facing relation;
c) an alignment member having a body portion and an alignment projection extending from the body portion, the body portion being mounted in the groove in the upper surface of the second substrate and the alignment projection being mounted in the groove in the upper surface of the first substrate.

16. The optical assembly of claim 15 wherein the first and second optical elements are selected from the group consisting of a lens, filter, optical fiber, laser diode and photodetector.

17. A method for manufacturing an optical system having first and second substrates with optical elements associated therewith, comprising the steps of:
a) positioning the first and second substrates in adjacent superposed relationship, each substrate having at least one mounting region with at least one groove in each mounting region;
b) engaging an alignment member with each mounting region, the alignment member having a body portion and an alignment projection extending from the body portion.

18. The method of claim 17 wherein the step of engaging the alignment member comprises mounting the body portion of the alignment member in the groove of the mounting region of the second substrate and mounting the alignment projection in the groove of the mounting region of the first substrate.

19. The method of claim 18 wherein the body portion includes at least one flat alignment surface and the groove in the mounting portion of the second substrate includes at least one flat side wall, and the step of mounting the body portion of the alignment member in the groove of the mounting region of the second substrate comprises positioning the flat alignment surface in flush engagement with the flat side wall.

20. The method of claim 17 wherein the alignment member is fabricated by:
a) providing a jig having a first portion with a first groove and a second portion with a second groove, said first and second portions of the jig being configured and dimensioned to correspond to the configuration and dimensions of the mounting regions of the first and second substrate;
b) mounting the alignment projection of the alignment member in the first groove;
c) mounting the body portion of the alignment member in the second groove; and,
d) bonding the alignment projection to the body portion.
